(19) United States
(12) Patent Application Publication
(10) Pub. No.: US 2026/0326405 A1
(43) Pub. Date: Oct. 22, 2026

(54) CARRYING HAND, PRESSING MACHINE, AND PRESSING METHOD

(71) Applicant: KOMATSU NTC LTD., Toyama (JP)

(72) Inventor: Yuji KANEHIRA, Toyama (JP)

(73) Assignee: KOMATSU NTC LTD., Toyama (JP)

(21) Appl. No.: 19/529,359

(22) Filed: Feb. 4, 2026

(30) Foreign Application Priority Data
Feb. 7, 2025 (JP) 2025019243

(51) Int. Cl. B30B 15/30; B25J 11/00; B25J 15/02; B30B 15/06

(52) U.S. Cl. CPC B30B 15/30; B25J 11/005; B25J 15/0253; B30B 15/062

(57) ABSTRACT

A carrying hand includes: a gripping plate made of a flat plate-like member; and gripping claws made of two or more rod members arranged parallel to each other along a plate surface of the gripping plate, wherein the carrying hand is transformable between a gripping mode in which the gripping claws are positioned in a space above the plate surface of the gripping plate and grip a stacked assembly having a positive electrode sheet, a negative electrode sheet, and a separator used for a secondary battery stacked on each other, and a retraction mode in which the gripping claws are retracted from the space above the plate surface of the gripping plate.

### CROSS-REFERENCE TO RELATED APPLICATION

This application claims the benefit of priority under 35 U.S.C. §119 to Japanese Patent Application No. 2025-019243 filed on February 7, 2025, the entire contents of which are incorporated herein by reference.

### TECHNICAL FIELD

The present invention relates to a carrying hand, a pressing machine, and a pressing method used when manufacturing a secondary battery.

### BACKGROUND OF THE INVENTION

When manufacturing a secondary battery, a pressing step of pressing a stacked assembly composed of stacked sheet materials (electrodes and separators) ) has been executed. During this pressing step, the stacked sheet materials are provisionally held in position to prevent misalignment before pressing.

### SUMMARY

### Problems to be Solved

In this regard, Japanese Patent Application Publication No. 2023-552532 (hereinbelow referred to as Patent Document 1) discloses a method of executing pressing twice during the pressing step. The proposed method applies a force greater than that used for provisional holding, when the gripper clamps the stacked assembly, to execute the first pressing. The first pressing ensures that the stacked sheet materials do not shift unintentionally, and then a second pressing is executed using pressing blocks. However, the gripper is formed in a comb-like shape when such a mode and a method are used, and fails to apply even pressure to the stacked assembly, to be liable to uneven pressure.

The present disclosure has been made in view of the above-described problems and is intended to provide a carrying hand, a pressing machine, and a pressing method that are capable of pressing with even pressure without misalignment of the stacked sheet materials.

### Solution to Problems

To achieve the above-described objective, a carrying hand according to the present disclosure comprises: a gripping plate made of a flat plate-like member; and gripping claws made of two or more rod members arranged parallel to each other along a plate surface of the gripping plate, wherein the carrying hand is transformable between a gripping mode in which the gripping claws are positioned in a space above the plate surface of the gripping plate and grip a stacked assembly having a positive electrode sheet, a negative electrode sheet, and a separator used for a secondary battery stacked on each other, and a retraction mode in which the gripping claws are retracted from the space above the plate surface of the gripping plate.

### Advantageous Effects of the Invention

The present disclosure provides a carrying hand, a pressing machine, and a pressing method that are capable of pressing with even pressure without misalignment of the stacked sheet materials.

### BRIEF DESCRIPTION OF DRAWINGS

FIG. 1 is a top perspective view of a pressing machine of an embodiment, with a stacked assembly placed on a provisional carrier tray;

FIG. 2 is a top perspective view of the pressing machine, with gripping claws inserted into claw grooves;

FIG. 3 is a bottom perspective view of the pressing machine, with the gripping claws inserted into the claw grooves;

FIG. 4 is a top perspective view of the pressing machine, with a chuck moving while gripping the stacked assembly;

FIG. 5 is a top perspective view of the pressing machine, with the provisional carrier tray in motion;

FIG. 6 is a top perspective view of the pressing machine, with a lower platen moved to a pressing position;

FIG. 7 is a top perspective view of the pressing machine, with a gripping plate placed on the lower platen;

FIG. 8 is a top perspective view of the pressing machine, with the gripping claws retracted from the lower platen; and

FIG. 9 is a side view of the pressing machine, with the gripping claws retracted from the lower platen.

### DETAILED DESCRIPTION

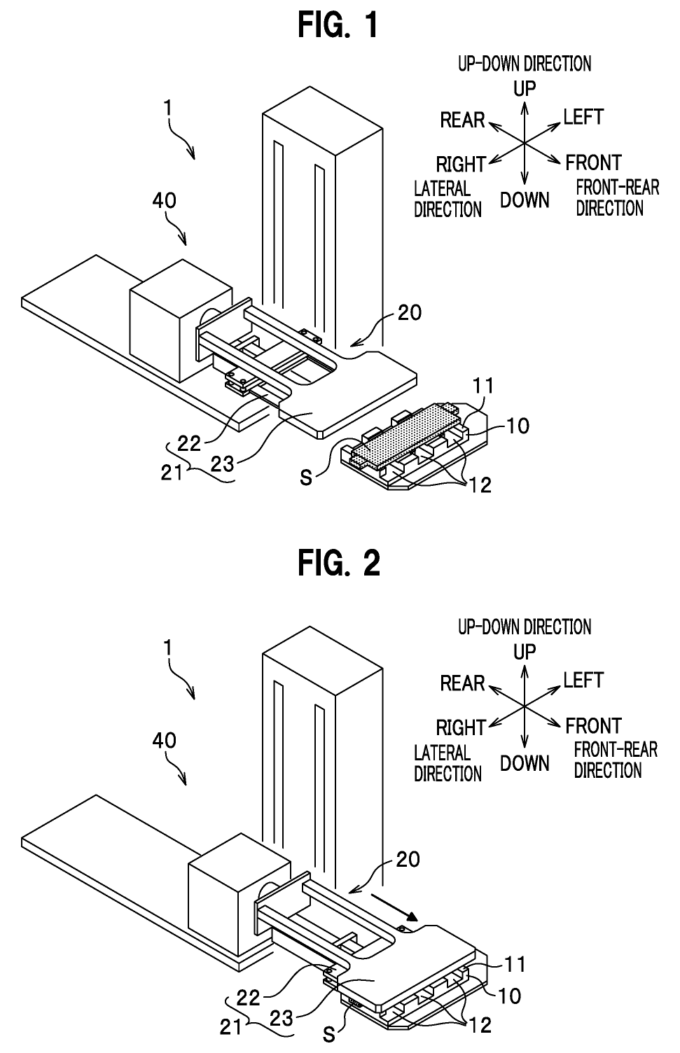

A description is given in detail of a pressing machine 1 equipped with a carrying hand 20 according to an embodiment of the present disclosure, with reference to FIGS. 1 to 9. Note that identical elements are denoted by the same reference signs and duplicate descriptions thereof are skipped. The pressing machine 1 of the embodiment is a device for pressing a stacked assembly S, having sheet materials (not shown) cut to predetermined dimensions stacked on each other, into a single member. The sheet materials of the stacked assembly S mainly include a positive electrode sheet, a negative electrode sheet, and a separator. These sheet materials are stacked into one to form a single cell of a secondary battery.

The two or more cells are then stacked into a unit to form a secondary battery that meets specifications. The pressing machine 1 is provided with a workspace in front thereof. Then, an end of occupation with the workspace is referred to as front, while an end of occupation with the pressing machine 1 as rear. Additionally, vertically above the pressing machine 1 is referred to as up, while vertically below the pressing machine 1 is referred to as down. A left-right direction of the pressing machine 1 is referred to as a lateral direction.

As shown in FIGS. 1, 6, and 9, the pressing machine 1 of the embodiment includes a provisional carrier tray 10, a carrying hand 20, a pressing mechanism 30, and a drive mechanism 40. The provisional carrier tray 10 is configured to have the stacked assembly S provisionally placed thereon before pressing. The positive electrode sheet (sheet material), negative electrode sheet (sheet material), and separator (sheet material) are stacked on the provisional carrier tray 10 in a predetermined order and quantity to form the stacked assembly S.

The provisional carrier tray 10 includes a provisional carrier surface 11 and claw grooves 12. The provisional carrier surface 11 is a horizontal flat surface formed on an upper surface of the provisional carrier tray 10. The provisional carrier surface 11 has the stacked assembly S provisionally placed thereon. The three (or more) claw grooves 12 are provided on the provisional carrier surface 11. The claw grooves 12 are arranged to extend linearly along a front-rear direction so as to be parallel to each other at predetermined intervals. The claw grooves 12 each have a rectangular shape in cross-section, opening upward.

The carrying hand 20 is configured to carry the stacked assembly S from the provisional carrier tray 10 to a lower platen 31 to be described below. The carrying hand 20 includes a chuck 21. The chuck 21 is configured to grip the stacked assembly S and includes gripping claws 22 and a gripping plate 23. The chuck 21 is transformable into gripping, releasing, and retraction modes, using the drive mechanism 40 as a drive source.

The gripping claws 22 are composed of two rod members arranged parallel to each other along the front-rear direction, and supported at their rear ends by the drive mechanism 40, with the claws facing the gripping plate 23. The gripping claw 22 are arranged such that the left gripping claw 22 is inserted into the claw groove 12 at the left end, while the right gripping claw 22 is into the claw groove 12 at the right end. The two rod members of the gripping claws 22 are cross-sectionally formed to fit within the claw grooves 12, respectively.

The gripping plate 23 is a flat plate-like member having a rectangular shape and supported at its rear end, while facing the gripping claws 22. The gripping plate 23 has a lower press die (one of a pair of press dies) formed on a surface facing the gripping claws 22, and a flat surface formed on the opposite side.

The gripping mode is a mode in which the gripping claws 22 and gripping plate 23 come close to each other and grip the stacked assembly S (see FIGS. 4 to 7). A level of a force of gripping the stacked assembly S is set such that the sheet materials of the stacked assembly S do not plastically deform and the stacked assembly S does not collapse even when carried in a way of rotating upside down.

The releasing mode is a mode in which a distance between the gripping claws 22 and gripping plate 23 is vertically greater than the thickness (height) of the stacked assembly S (see FIGS. 1 to 3). That is, the releasing mode is the mode before the stacked assembly S on the provisional carrier tray 10 is gripped and after the stacked assembly S has been carried to the lower platen 31.

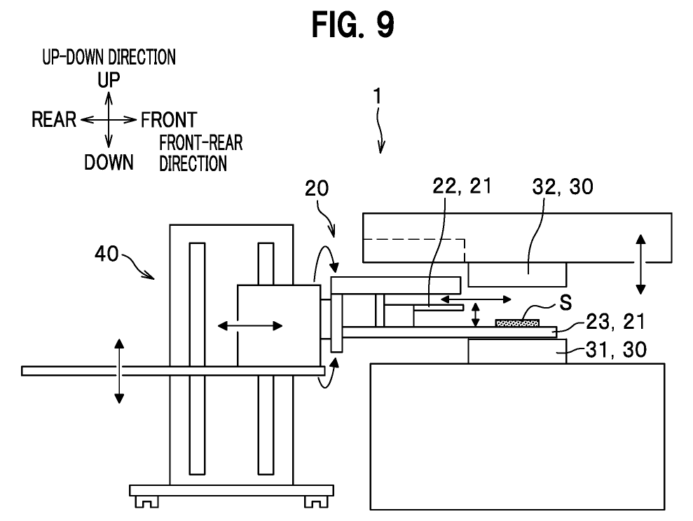

The retraction mode is a mode in which the gripping claws 22 are moved backward and retracted from a space above the gripping plate 23 (see FIGS. 8 and 9). The chuck 21 is transformed to the retraction mode when the stacked assembly S on the gripping plate 23 is pressed, with the gripping plate 23 being placed on the lower platen 31.

The pressing mechanism 30 is configured to press the stacked assembly S, composed of two or more sheet materials, into a single member. The pressing mechanism 30 includes the lower platen 31 and an upper platen 32. The lower platen 31 is arranged to be movable between a standby position and a pressing position.

The lower platen 31 has a flat surface on its upper side for placing the gripping plate 23. The upper platen 32 has an upper press die (the other of the pair of press dies) formed in its face (lower surface thereof) facing the lower platen 31. The upper press die is paired with the lower press die of the gripping plate 23 to form a pair of press dies. The upper platen 32 is arranged to come close to and move away from (vertically movable with respect to) the lower platen 31.

The drive mechanism 40 is configured to drive the chuck 21, move the provisional carrier tray 10, move the pressing mechanism 30, and move the carrying hand 20 from the provisional carrier tray 10 to the pressing mechanism 30.

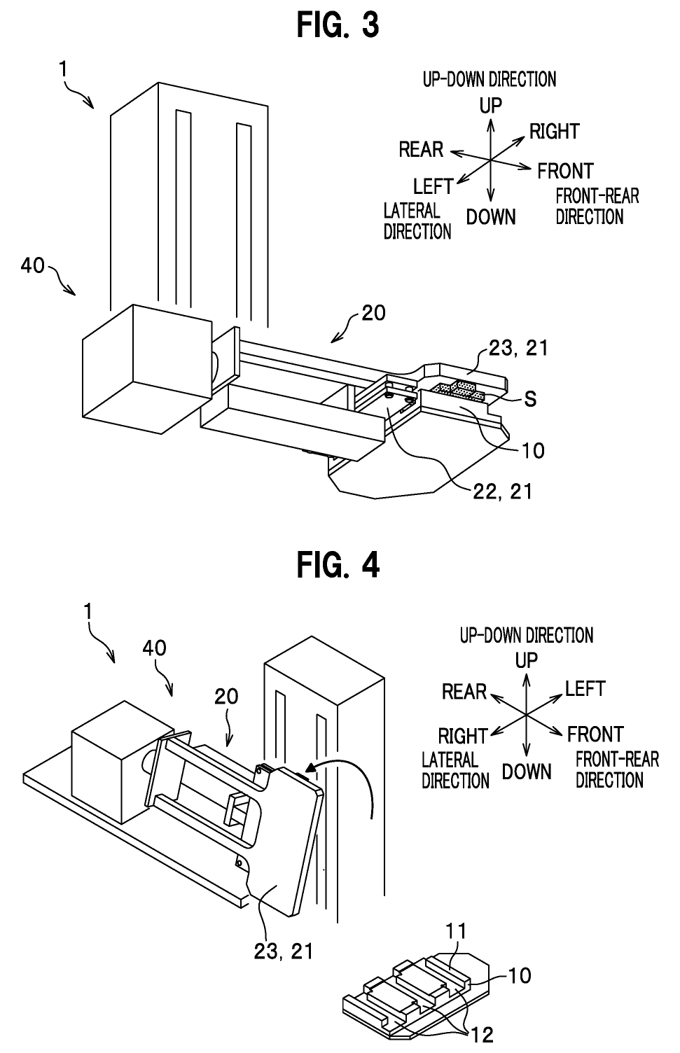

Hereinbelow, a description is given of operation of the pressing machine 1. First, the stacked assembly S is placed on the provisional carrier tray 10 (see FIG. 1). Then, the chuck 21 in the releasing mode is slid frontward from the rear toward the provisional carrier tray 10, with the gripping claws 22 below and the gripping plate 23 above, and the gripping claws 22 are inserted from their front ends into the claw grooves (see FIGS. 2 and 3). This motion moves the gripping plate 23, along with the gripping claws 22, above the stacked assembly S on the provisional carrier tray 10.

Then, the gripping plate 23 is lowered vertically, and the chuck 21 is transformed from the releasing mode to the gripping mode, to grip the stacked assembly S. Then, the hand and stacked assembly are rotated upside down, with the chuck 21 gripping the stacked assembly, while both the hand and stacked assembly are moved upward and backward from the provisional carrier tray (see FIG. 4). That is, the chuck 21 is withdrawn backward from the space above the provisional carrier tray 10, while gripping the stacked assembly S in the order of the gripping claws 22, stacked assembly S, and gripping plate 23 from the top.

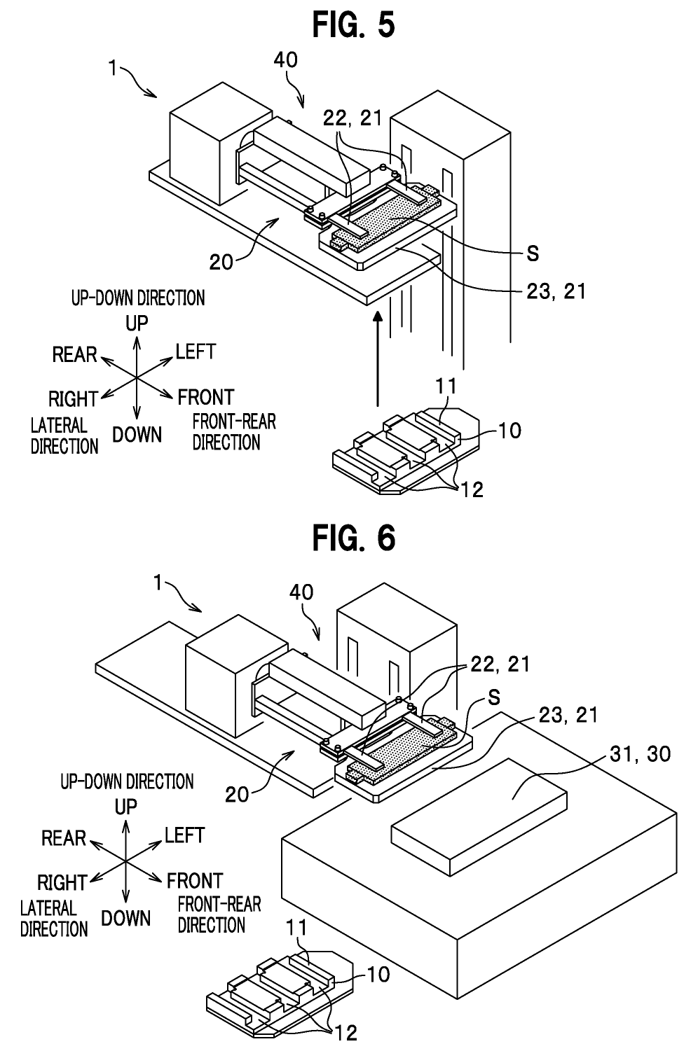

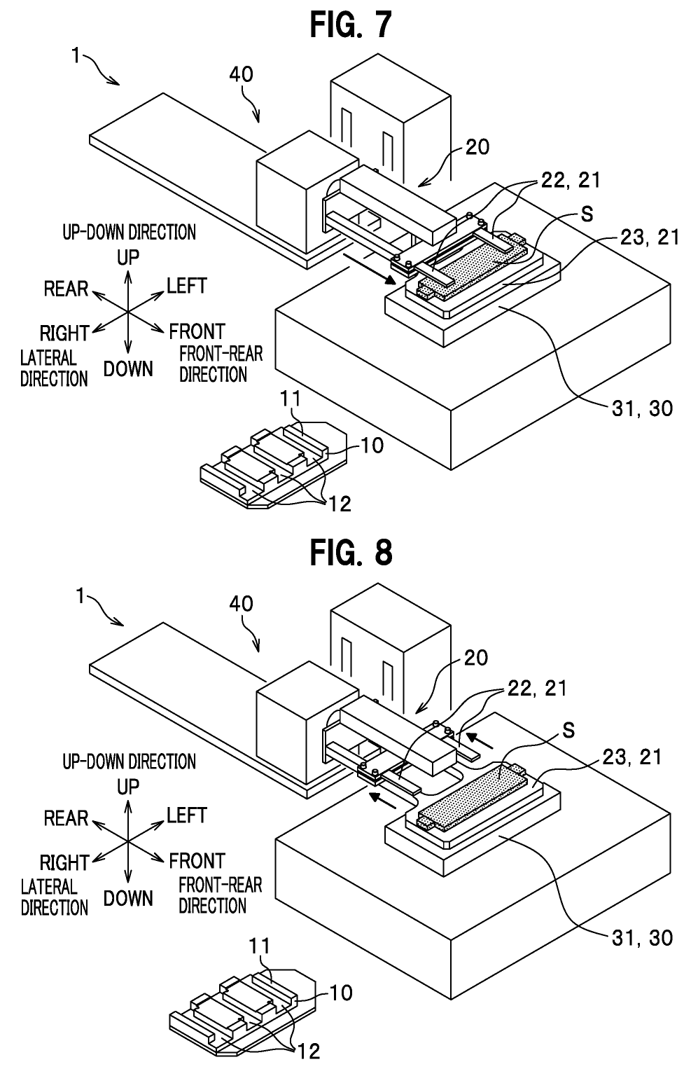

The provisional carrier tray 10 is then moved away, and the lower platen 31 in the standby position is moved to the place (pressing position) where the provisional carrier tray 10 has been placed (see FIGS. 5 and 6). The chuck 21 gripping the stacked assembly S is advanced and lowered to place the stacked assembly S on the lower platen 31 (see FIG. 7). That is, the stacked assembly S is placed on the lower platen 31 via the gripping plate 23.

Then, the chuck 21 is transformed from the gripping mode to the releasing mode. That is, the gripping claws 22 are lifted, with the gripping plate 23 placed on the lower platen 31, away from the stacked assembly S.

Then, the chuck 21 is transformed from the releasing mode to the retraction mode (see FIG. 8). That is, the gripping claws 22 are moved backward from the lifted position, with the gripping plate 23 placed on the lower platen 31. In other words, the gripping claws 22 are retracted from the space above the lower platen 31 (a region where the upper press die of the upper platen 32 works).

Then, the upper platen 32 is moved above the lower platen 31 (see FIG. 9). The upper platen 32 is lowered to press the stacked assembly S together with the gripping plate 23 on the lower platen 31, to form the sheet materials into a single member. Note that the press dies are designed to apply pressure evenly to the positive and negative electrode sheets during pressing.

Next, a description is given of advantageous effects of the pressing machine 1 including the carrying hand 20 according to the embodiment. The carrying hand 20 of the embodiment is transformable into releasing, gripping, and retraction modes. Such a configuration prevents misalignment of the sheet materials of the stacked assembly S when the stacked assembly S is moved from the provisional carrier tray 10 to the lower platen 31. This enhances pressing accuracy without causing cycle time loss.

In addition, the carrying hand 20 of the embodiment is supported so as to be rotated upside down while gripping the stacked assembly S (in the gripping mode). Such a configuration allows the carrying hand 20 to insert the gripping claws 22 into the claw grooves 12 in the releasing mode, with the stacked assembly S placed on the provisional carrier tray 10, and grip the stacked assembly S in the gripping mode after transformation, as well as to place the stacked assembly S on the lower platen 31 via the gripping plate 23. This prevents misalignment of the sheet materials of the stacked assembly S when the stacked assembly S is carried from the provisional carrier tray 10 to the lower platen 31.

Further, the pressing machine 1 according to the embodiment has the lower press die (one of the pair of press dies) formed on the gripping plate 23 and the upper press die (the other of the pair of press dies) formed on the upper platen 32. Such a configuration allows applying load evenly to the stacked assembly S during pressing, to complete the pressing in a single step.

Still further, the pressing machine 1 of the embodiment has the claw grooves 12 provided on the provisional carrier tray 10, into which the gripping claws 22 can be inserted. Such a configuration allows the chuck 21 to grip the stacked assembly S without misalignment of the stacked sheet materials.

Hereinabove, the preferred embodiment of the present disclosure has been described but the present disclosure is not limited thereto and can be modified as appropriate without departing from its spirit. For example, the provisional carrier tray may be formed in a comb-like shape using a number of rods provided along a horizontal plane and being parallel to each other. Such a configuration allows the gripping claws to be inserted between the comb teeth. Such a configuration also achieves similar advantageous effects as those of the embodiment.

In addition, the provisional carrier tray may be divided into a number of elements (not shown) at the claw grooves 12, and such a configuration also achieves similar advantageous effects as those of the embodiment.

Further, the gripping claws 22 in the releasing mode is moved backward from the lower platen 31 in the case of the embodiment, to retract the gripping claws 22 from the space above the lower platen 31, but the present disclosure is not limited to this configuration. For example, the gripping claws 22 may be provided at its rear end with a hinge (not shown) and pivoted (folded) on the hinge so as to have its front end folded backward, for retraction. Such a configuration also achieves similar advantageous effects as those of the embodiment.

Still further, the two gripping claws 22 support the stacked assembly S in the case of the embodiment, but the present disclosure is not limited to this configuration. For example, three gripping claws may be provided so as to be inserted into all of the three claw grooves 12 of the provisional carrier tray 10. That is, the gripping claws 22 may be provided in a comb-like shape, as far as allowing stable handling with less force when gripping and moving the stacked assembly S.

Still further, such a configuration is possible that the gripping plate 23 is placed on the provisional carrier tray 10, the stacked assembly S is formed on the gripping plate 23, and the gripping plate 23 is moved to the lower platen 31, while the carrying hand 20 stays in the retraction mode. Such a configuration also achieves similar advantageous effects as those of the embodiment.

Still further, the pressing mechanism 30 of the embodiment is configured to move the provisional carrier tray 10 and lower platen 31, but the present disclosure is not limited to this configuration. For example, the provisional carrier tray 10 and lower platen 31 may be arranged on a front side and a rear side of the carrying hand 20, allowing the gripped stacked assembly S to be moved from the provisional carrier tray 10 to the lower platen 31.

### LIST OF REFERENCE SIGNS

1: pressing machine, 10: provisional carrier tray, 11: provisional carrier surface, 12: claw groove, 20: carrying hand, 21: chuck, 22: gripping claw, 23: gripping plate, 30: pressing mechanism, 31: lower platen, 32: upper platen,40: drive mechanism, and S: stacked assembly.

What is claimed is:

1. A carrying hand comprising:
a gripping plate made of a flat plate-like member; and
gripping claws made of two or more rod members arranged parallel to each other along a plate surface of the gripping plate,
wherein the carrying hand is transformable between
a gripping mode in which the gripping claws are positioned in a space above the plate surface of the gripping plate and grip a stacked assembly having a positive electrode sheet, a negative electrode sheet, and a separator used for a secondary battery stacked on each other, and
a retraction mode in which the gripping claws are retracted from the space above the plate surface of the gripping plate.

2. The carrying hand according to claim 1, wherein
the carrying hand is supported so as to be rotated upside down while in the gripping mode.

3. A pressing machine comprising:
the carrying hand according to claim 1;
a lower platen formed to have the gripping plate, when the carrying hand is in the retraction mode, placed on its upper side;
an upper platen arranged to come close from above to, and move away from, the lower platen; and
a pair of press dies,
wherein one of the pair of press dies is formed on an upper surface of a gripping plate placed on the lower platen, and
the other of the pair of press dies is formed on a lower surface of the upper platen.

4. The pressing machine according to claim 3, further comprising:
a provisional carrier tray configured to have the stacked assembly provisionally placed thereon
wherein the provisional carrier tray includes claw grooves into which the gripping claws can be inserted.

5. A pressing method using the pressing machine according to claim 4, the method comprising:
gripping the stacked assembly with the carrying hand, the stacked assembly being provisionally placed on the provisional carrier tray;
placing the gripping plate of the carrying hand on the lower platen, the carrying hand gripping the stacked assembly;
releasing the stacked assembly from the carrying hand;
retracting the gripping claws of the carrying hand from a space above the upper surface of the gripping plate; and
lowering the upper platen and pressing the stacked assembly together with the gripping plate on the lower platen.

6. The pressing method according to claim 5, further comprising:
rotating the carrying hand upside down, while the carrying hand gripping the stacked assembly.
